(19) United States
(12) Patent Application Publication
(10) Pub. No.: US 2009/0100321 A1
(43) Pub. Date: Apr. 16, 2009

(54) UNIVERSAL CONTEXTUAL ACTIONS MENU ACROSS WINDOWS APPLICATIONS

(75) Inventors: Harsh Vardhan Singh, Hyderabad (IN); Jagdeesh Shukla, Pune (IN); Anup Sivadas, Hyderabad (IN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/871,670

(22) Filed: Oct. 12, 2007

(51) Int. Cl. G06F 15/00

(52) U.S. Cl. 715/205

(57) ABSTRACT

A universal way of providing contextual actions on electronic business forms or rich documents in a consistent manner irrespective of the document format or its hosting application utilizes metadata along with the actual data that will invoke the same context menu in any application. Actions can be taken on the document or GUI data field regardless of the hosting application or the document format. This seamless behavior is provided through first provisioning the context data in the document or the GUI field as a hyperlink with a custom protocol. The contextual information available at predetermined places in the document is preserved during document format transformation or document transition. Second, providing relevant actions to the user in a consistent manner at the predetermined places in the document is accomplished by creating and registering a Protocol Handler that will be invoked when a user clicks on the hyperlink.

### BACKGROUND

Nearly all business processes revolve around documents of various kinds and on electronic versions of those documents. Examples of common business documents include invoices, sales orders, purchase orders, work requests, delivery receipts, sales and marketing reports, financial reports, etc. Computer based automation systems proliferate access to business documents in various electronic formats. The electronic documents may be presented to users in diverse ways. Electronic documents may be viewed as part of an application's Graphic User Interface (“GUI”) such as a word processor, presentation, or spreadsheet application; on a web page; as an attachment to an email; or through a work-flow managed portal. Typically, the host application utilized to create a document will provide actions that can be taken upon the data. For example, a contextual menu may be revealed upon a mouse click on a data field. The data field context may determine the parameter for the actions that are made available to the user. A context menu is a menu that is created in an application or software system, based on the context of the content being selected and/or viewed by the user. Context menus have traditionally been static based on the application in which the content is viewed. Today it is possible that information or data coming from a particular line-of-business application could be viewed under different formats opened under different applications (e.g., Microsoft® Word or Excel®, PDF, HTML, etc.). Advanced portals like Microsoft® Office SharePoint® Server (“MOSS”) can enable actions on this kind of data. Microsoft® Office applications provide context related actions if the document field is recognized as a Smart Tag.

Irrespective of the document format or its host application, a user who accesses the document in a different application may probably need to perform the same sorts of actions on the data. However, this is not possible due to the unrelated nature of context menus inside each different application. Each application creates and manages its own context menus. Once the content is out of control from the application, there is no way for the original application to provide such services. So once the hosting application is changed, or when the electronic version of the document is dispersed through various channels, or when the format of the document is changed, the actions on such data fields are usually lost. The data is still there but the document is now passive to the user. In the changed environment it typically is not possible to act on the data, or a document field, in the same manner as that provided by the host application because the context does not persist with the data across different applications.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

The detailed description below describes a universal way of providing contextual actions on electronic business forms or rich documents in a consistent manner irrespective of the document format or its hosting application. A method is used to specify metadata along with the actual data that will invoke the same context menu in any application, plus for those applications where the context menus are dynamic and extensible, allow for application specific actions to be taken. The solution described below enables actions to be taken on the document or GUI data field regardless of the hosting application or the document format. This seamless behavior is provided through a two step approach. First, a way of provisioning the context data in the document or the GUI field in the host application is provided. This provisioning is such that the contextual information available at predetermined places in the document is preserved during document format transformation or document transition to a second application. Second, a way of providing the relevant actions to the user in the second application in a consistent manner at the predetermined places in the document or GUI field is provided.

### BRIEF DESCRIPTION OF THE SEVERAL VIEWS OF THE DRAWINGS

FIG. 1 shows a screen capture of contextual actions on a report field inside Microsoft® Outlook®.

FIG. 2 shows a screen capture of contextual actions on a report field inside Microsoft® Outlook® with Microsoft® Office Communicator running.

FIG. 3 shows a screen capture of contextual actions on a report field inside Microsoft® Internet Explorer.

FIG. 4 shows a screen capture of contextual actions on a report field inside Adobe® Reader®.

FIG. 5 shows a screen capture of contextual actions on a report field inside Microsoft® Excel®.

FIG. 6 shows a screen capture of contextual actions on a report field inside Microsoft® Internet Explorer in a web archive format.

FIG. 7 shows a block diagram illustrating an exemplary operating environment.

FIGS. 8A and 8B show the overall flow of an embodiment of provisioning context data and providing relevant actions based on the context data.

### DETAILED DESCRIPTION

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

With the computing environment in mind, embodiments of the present invention are described with reference to logical operations being performed to implement processes embodying various embodiments of the present invention. These logical operations are implemented (1) as a sequence of computer implemented steps or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts, and modules may be implemented in software, in firmware, in special purpose digital logic, and any combination thereof without deviating from the spirit and scope of the present invention as recited within the claims attached hereto. The following description of an illustrative embodiment is presented within the context and environment of the Windows® operating system. Later, it will become apparent to one skilled in the art that other operating systems may also be utilized.

The provisioning method allows context data to be put behind a data field. A nearly universal way to provide an actionable data or document field or GUI field is to provision it as a hyperlink. A hyperlink is “clickable” with a mouse and in most instances will be preserved during document transition or format transformation. For example, if a Microsoft® Word document containing a hyperlink is converted to PDF format, the hyperlink is still clickable in the PDF formatted version of the document. Any host application that supports hyperlinks and clickable fields may utilize the provisioning method described herein.

Generally, hyperlinks are provided in a document for navigational purposes to allow a user to move to another section of the same document, to move to another document, or to move to a specified section of another document, by clicking on a hyperlink. If the hosting application is unable to handle the URL hyperlink, it passes it to the Windows® operating system, which in turn consults its registry to check to see if the application has registered itself as a hook to handle this protocol. The Windows® operating system protocol handling capability enables the use of hooks and handlers for standard and custom protocols, such as Hypertext Transfer Protocol (“HTTP”), File Transfer Protocol (“FTP”), MailTo, etc. Whenever a hyperlink segment is discovered by a hosting application, such as Internet Explorer, or Microsoft® Outlook®, or a GUI system, such as Windows® Forms, the hosting application provides a clickable item mapped to the hyperlink. When a user clicks on such an item, for example a hyperlink in Hypertext Markup Language (“HTML”), the Windows® operating system will handle the URL based upon the invocation syntax of the hooked application, which is defined in the in the Windows® registry.

The provisioning method utilizes a new protocol for the hyperlink URL (described in detail below) that will be consumed, or acted upon, by the registered Protocol Handler application to create the desired Context Menu for any Windows® application. The metadata (any extra information required to create the Context Menu) will be embedded as part of the hyperlink in the data itself, thereby extending mere navigation capabilities to more complex actions. The context data hyperlink follows the usual Uniform Resource Identifier (“URI”) syntax. For a given document field or location, contextual data can be associated with the field or location by making it a hyperlink. The field display value or location value would be the same, but it will be encoded with the metadata behind the field or location as a hyperlink URL. Consider the following first four rows of a simple business document, created utilizing SQL Server 2005 Reporting Services (“SSRS”) and the appropriate SQL Server queries:

Simple Business Document

| NAME | SALES LAST YEAR | BONUS |
|---|---|---|
| Mr. Gary Drury | 0.0000 | 0.0000 |
| Mr. Maciej Dusza | 1750406.4785 | 4100.0000 |
| Ms. Shelley Dyck | 1493156.0291 | 2000.0000 |
| Ms. Linda Ecoffey | 1997186.2037 | 2500.0000 |

For example, while viewing this sales report, the reviewer may want to communicate with one or more of the sales persons. It would be of tremendous benefit if the sales report could provide some collaboration actions to the reviewer when he or she clicks on the sales person's name, from within the report itself, to reveal more data currently hidden. From the record for the person's name in the SQL database the other fields associated with that record, such as that person's telephone number, email address, employee identification number, etc., can be accessed. Here, the context is the contact whose name is displayed in the sales person name column in the report. Possible actions on this type of contact field could be to start an email to that person or schedule a meeting with that person. If a communicator service is available it would be advantageous to provide Instant Messaging (“IM”) related actions like start chat, call PC, etc.

However, the SQL Server Reporting Services using the RDL Viewer Component is not capable of this level of report interactivity. The provisioning method allows context data to be hidden behind the report data fields, precisely at the report cell or the column level, or in other specified locations within the document. The context data provisioning is generic and takes advantage of the hook that RDL provides that allows embedding a hyperlink URL on a report field, or in the middle of a sentence, or anywhere in the document. The report renderer preserves the link property while producing the report in various formats. By controlling the report panel, a click event on the hyperlink can now be listened for and, based on the context data (encoded in the custom link URL) a set of possible actions and available services, such as mailing client, communicator, enterprise search, etc. can be accessed. However, once the report is moved out of the creation application, and viewed in say Adobe® Acrobat Reader® or Internet Explorer, the report would not possess the contextual interactivity it had. In order to maintain the consistency and the seamless behavior desired, a custom protocol is registered in the Windows® operating system that will be invoked when a user clicks on a hyperlink as described below.

Assuming the custom protocol is called “ctxdata” the hyperlink must be created in the following forms in these popular environments:

HTML
<a href=“ctxdata://handler_name?name1=val1;...”>Display Name</a>
SQL Server Reporting Services

| | |
|---|---|
| Report Data Field - | Properties: Jump to URL -> |
| | ctxdata://handler_name?name1=val1;... |

MOSS/SharePoint ® Server
Through WSS Object model item[“Hyperlink”]

=“ctxdata://handler_name?name1=val1;...”

Microsoft ® Word/Excel ®/PowerPoint ®
Select Text -> Properties -> Hyperlink

ctxdata://handler_name?name1=val1;...

```
Windows ® Forms Set Hyperlink Property
                  Or, On Click -> Invoke navigate to
                  ’ctxdata://handler_name?...’
```

In the above examples, the context data URL has following segments:

| | | |
|---|---|---|
| Protocol: | ’ctxdata’ | The custom protocol name. |
| Handler Name: | ’handler_name’ | The handler to consume this data. |
| Context Data: | ’name1’=’val1’... | URI encoded name-value pairs. |

There is nothing that needs to be done to the software program in which the business document is created. In our example above, the provisioning method uses the existing SQL Server and the SQL Server Reporting Services. All that is required is that the hyperlink must be created in the format shown above when relating it to a particular record. The user generating the SQL queries to prepare the report needs only to provision the hyperlink in one of the formats shown above based upon the environment the report is created. In the Simple Business Document, only the fields in the Name column have been provisioned with the custom hyperlink.

Providing relevant actions to the user is accomplished by creating and registering the Protocol Handler that will be invoked when a user clicks on a hyperlink as shown above. This will typically be a left mouse click as a right mouse click is typically tied up in the host application. A Protocol Handler has to be registered for the associated protocols it handles. The Windows® operating system will check for a registry entry to invoke the appropriate handler. A hyperlink starting with HTTP can be handled by Internet Explorer if it is registered as the default browser. For example, MailTo is registered by Microsoft® Outlook® as:

[HKEY_CLASSES_ROOT\mailto\shell\open\command]
@=“\” ... \\Office12\\OUTLOOK.EXE\“ -c IPM.Note /m \”%1\“”

To register a custom Protocol Handler for ctxdata, a registry entry like the following can be made:

[HKEY_CLASSES_ROOT\ctxdata\shell\open\command]
@=“C:\\CtxDataProtocolHandler\\bin\\CtxDataProtocolHandler.exe \
”%1\“”

Once the ctxdata handler is registered, it will be called whenever the Windows® operating system needs to handle the protocol request. This registration ensures that the Windows® operating system invokes

“C:\\CtxDataProtocolHandler\\bin\\CtxDataProtocolHandler.exe”

whenever a hyperlink (such as any of the ones shown above with the ctxdata protocol) is clicked (in any Windows® application) and passes in the hyperlink as a parameter. For example, whenever a user clicks on a hyperlink whose protocol is specified as ctxdata, the Windows® operating system will invoke the registered handler CtxDataProtocolHanlder.exe with the hyperlink URL as a command line parameter.

The handler application can be a small Windows® application but without any GUI element. Its invocation will not be noticed by the user. Alternatively, a single instance application can be re-invoked which can serve as the custom Protocol Handler. In such a case the handler has to be running when the Windows® operating system notifies it by the next invocation (as is the case with Microsoft® Outlook® handling MailTo protocol requests).

When a contextual hyperlink is clicked on by a user, the Windows® operating system will invoke the registered custom Protocol Handler with the hyperlink URL text as the command line parameters. This Protocol Handler will pass this information, the context data URL text, to the associated Context Data Handler. The Context Data Handler is the consumer for this kind of context data. The handler could be in form of a Windows® service or a module of a running application (for example, a Microsoft® Outlook® add-in). Based on the requirements, the context data could be varied and may be handled by various respective handlers, since it is possible to have multiple Context Data Handlers in an operating system. It will be the responsibility of the Windows® Protocol Handler to check for a registry entry for the handler name in the context data URL and route it to the appropriate handler. The Windows® Protocol Handler and the Context Data Handler are two separate processes. The appropriate Inter-Process Communication (“IPC”) mechanism is discussed below.

The context data hyperlink text will then be parsed by the Context Data Handler to create a context data dictionary. The context data dictionary is nothing but a simple <string, string> map. The Context Data Handler will go through the available context names and will decide on the possible contextual actions that it can provide to the user. The contextual actions set will depend on the availability of the configured services. For example, if Microsoft® Office Communicator is running, it will enable the Instant Messaging (“IM”) related actions, and otherwise, it will not. Also, some of the functionality available in the electronic document in the host application may not be applicable to the second application in which the user is accessing the electronic document. Thus, contextual actions made available to the user in the user's application may only be a subset of what is available in the host application. If the host application is aware of the ctxdata hyperlink, it can intercept and act upon the hyperlink natively, rather than passing it down to the Windows® operating system, which in-turn consults the registry to determine the appropriate Protocol Handler.

This end-to-end method involves various Windows® and Windows® .Net Framework features. One such feature is the Windows® protocol hook. The Windows® protocol is a way to invoke appropriate applications to handle a hyperlink. The following shows an implementation where the Protocol Handler is a separate program for the main contextual actions provider sitting as an add-in module in Microsoft® Outlook®, and therefore not reachable directly by the Windows® operating system. For the following discussion the add-in will be named CtxDataHandler. The main procedures of the end-to-end work-flow are shown in pseudo code below.

```
CtxDataHandler : Initialization
  Context: Outlook Initialization Thread (Thread Type : UI)
  Create a Named Shared Memory Segment, Say CtxDataShm
  Set Name of CtxDataShm to eureka_addin
  Create a Timer Task, CtxDataFeedListner
  Create a Memory GUI Element, InMemUIControl
  Request Creation of InMemUIControl Native Handle
  Start CtxDataFeedListener Task
CtxDataFeedListener : Timer Callback
  Context: Timer Callback (Type: Server Timer, Non UI)
  Save Current Mouse Position, clickPos
  Read CtxDataShm Shared Memory Segment into ctxData String
  If ctxData String is Null Return Back
  Parse ctxData to get Protocol Name, Handler Name
  If Not (Protocol Name = ctxdata and Handler Name = eureka_addin)
      Return
  Build Context Data Dictionary, ctxDD by Decoding ctxData
  Build Action Set Using ctxDD and Configured Services
  Call CtxMenuBuilder in the Context of InMemUIControl Creator
  Thread
CtxDataFeedListener : CtxMenuBuilder
  Context: Invoked in the Context of Outlook UI Thread
  Build the Context Menu Control for the Current Actions Set
  Register Call-Backs for the Actions
  Show the Context Menu at the clickPos
CtxDataProtocolHanlder : Main
  Context: Main Application Thread
  Parse the Command Line Argument to Find the Handler Name
  Attach to the Named Shared Memory Segment, Named Handler Name
  Copy the First Command Line Argument to it
  Exit
```

With the actual code represented by the pseudo code shown above in place, the add-in module in Microsoft® Outlook® will be able to respond to a hyperlink URL such as the following, in which the context data is in the form of various name-value pairs (email address, phone number, and employee identification number of an individual) to be handled using the ctxdata protocol:

ctxdata://eureka addin?email=hvs@company.com;phone=3033571632;empid=913195

The corresponding context data dictionary is:

| Name | Value |
|---|---|
| Email Address | hvs@company.com |
| Phone Number | 3033571632 |
| Employee ID | 913195 |

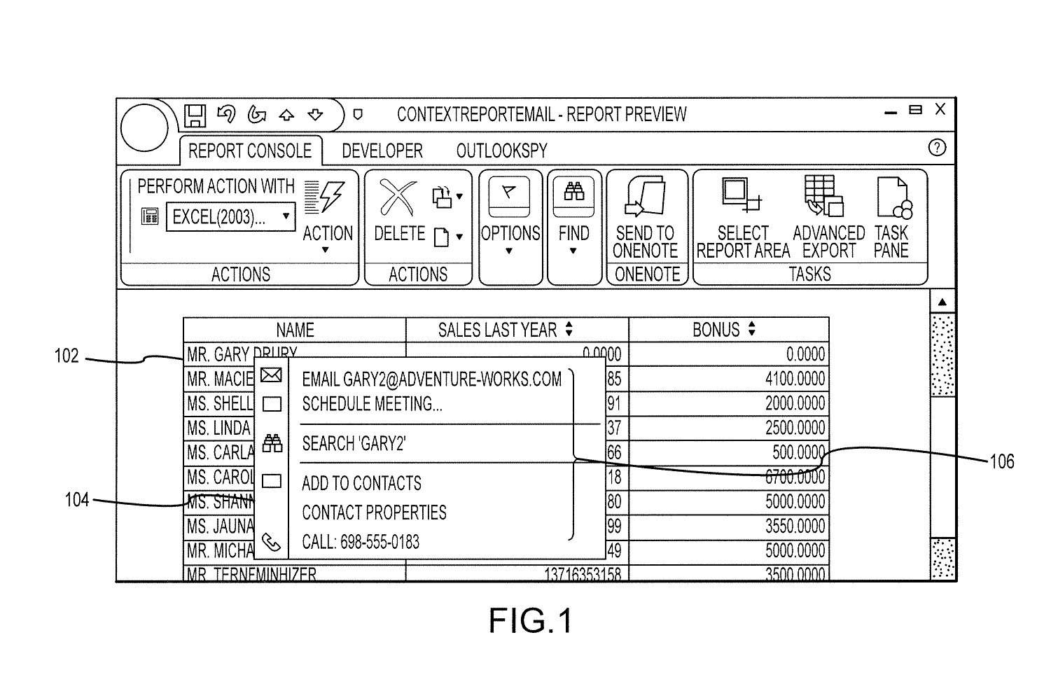

Using this context dictionary a set of actions can be enabled, such as Send Mail, Schedule a Meeting, Add to Contacts, Call Phone, etc. (see FIGS. 1-6 below). When the user clicks on the contact's name field (typically with a left mouse click), the Context Menu will appear giving the user the above options. The Context Data Handler (eureka_addin) will create the Context Menu using the name-value pairs in the URL.

The context data hyperlink text will be parsed by the Context Data Handler and based on the available context names it will decide on the possible contextual actions that it can provide to the user. The contextual actions set will also depend on the availability of the configured services on the system (e.g., the Context Data Handler will enable the IM related actions only if the Microsoft® Office Communicator is installed and running on the system).

As mentioned above, there can be multiple Context Data Handlers in a system. It is possible that an enterprise can create a Context Data Handler for its own needs and deploy it to various user machines. The approach discussed above is flexible enough to allow the custom Context Data Handler to create/invoke its own custom Context Menu as required.

Using the Microsoft® Outlook® add-in approach, the Protocol Handler executable will only intercept the user click on the hyperlink and pass the context data to the add-in (which acts as the Context Data Handler). The IPC is done using “named shared memory.” The add-in parses the hyperlink and creates the required Context Menu within the Windows® application in which the user clicked on the hyperlink. The Context Menu created upon intercepting the user click will be the same irrespective of the application in which the user clicked on the hyperlink (see FIGS. 1-6).

In this implementation named shared memory is used as the IPC mechanism between the ctxdata Protocol Handler and the actual context action provider. This is advantageous because there is no direct way to notify the custom action provider as it is sitting inside the Microsoft® Outlook® sandbox as an add-in. This is the fastest available and yet simple communication IPC mechanism in Windows®. Since named shared memory creation is a costly operation, it is created in the context data handler initialization code. The custom Protocol Handler just attaches to this memory segment and writes the hyperlink URL text and then exits. Using named shared memory automatically solves the problem of context data routing. It is possible to have multiple context data handlers (the custom menu and actions provider) in a system. The Protocol Handler can extract the handler name from the context data hyperlink URL and use it to map to the appropriate named shared memory. Of the possible notification mechanisms to know the availability of context data in the shared memory, in this implementation active polling is utilized. Ideally other cross-process notification mechanisms, such as a named condition variable, could be used. For security purposes, this communication channel should be protected, either by encrypting data in transition or applying appropriate security policies (read, write, or no access) among participants.

Exposing contextual information in the data field could be a possible security concern. Sensitive information should not be exposed in the context URL. In such cases an ID or key can be provided, which in turn can be used to get the sensitive information over the secure connection. If this solution is not feasible then the sensitive values should be encrypted with a key known only to the context data handler and the context data link URL generator.

Showing a context menu on a foreign application is a tricky and subtle issue. To imitate the natural behavior in a foreign environment care needs to be taken about certain GUI aspects and usability concerns. First, the Context Menu created using this technique has no parent control. It is a floating control. Its placement should be at the mouse click position, so it is prudent to capture the mouse position as soon as possible, and ideally in the Protocol Handler itself. The Context Menu placement should not deviate from the mouse click position.

Another concern is the lifetime of the Context Menu. In normal situations when a context menu is shown on its parent control, its lifetime is limited to current input focus over its parent. But since in this case the Context Menu will be parent-less, the lifetime of the Context Menu must be dealt with smartly. First, the Context Menu should be disposed if it looses the current keyboard focus. Second, if the mouse cursor has left the Context Menu boundary for more than a specified period (two seconds is a reasonable value) then it should be disposed of. The later behavior is somewhat similar to the context menus on a MOSS portal.

Referring now to the Figures, in which like reference numerals and names refer to structurally and/or functionally similar elements thereof, FIGS. 1-6 show how the same Context Menu containing actions that a user can take on the report data is made available from within different applications.

FIG. 1 shows a screen capture of contextual actions on a report field inside Microsoft® Outlook®. Referring now to FIG. 1, the simple business document shown above, created utilizing SQL Server 2005 Reporting Services, has been imported into Microsoft® Outlook®. The user has clicked on Report Field 102, causing Context Menu 104 to pop up at the mouse click site. The provisioning of the contextual information behind the data field as a custom hyperlink URL, and then consuming the data through a registered Protocol Handler, provides the Contextual Actions 106 within Context Menu 104 at the report field location. Contextual Actions 106 includes: Send an Email, Schedule a Meeting, Search, Add to Contacts, Contact Properties, and Place a Telephone Call.

The data in Context Menu 104 for Mr. Gary Drury is derived from the query to the database when the report was designed. The record retrieved from the database for Gary Drury holds the email address (GARY2@ADVENTURE-WORKS.COM) and phone number (698-555-0183) and employee ID. This extra data was embedded in the hyperlink for the report field containing “MR. Gary Drury.” Likewise, for the rest of the names in the Name column, the additional data associated with each of the records for the name of the individual are embedded in the hyperlink. The employee ID does not fit into any context available within Microsoft® Outlook®. Therefore, it does not appear in Context Menu 104. Context Menu 104 is only populated data from the original report document plus the actions that can be taken upon that data within the context of Microsoft® Outlook®.

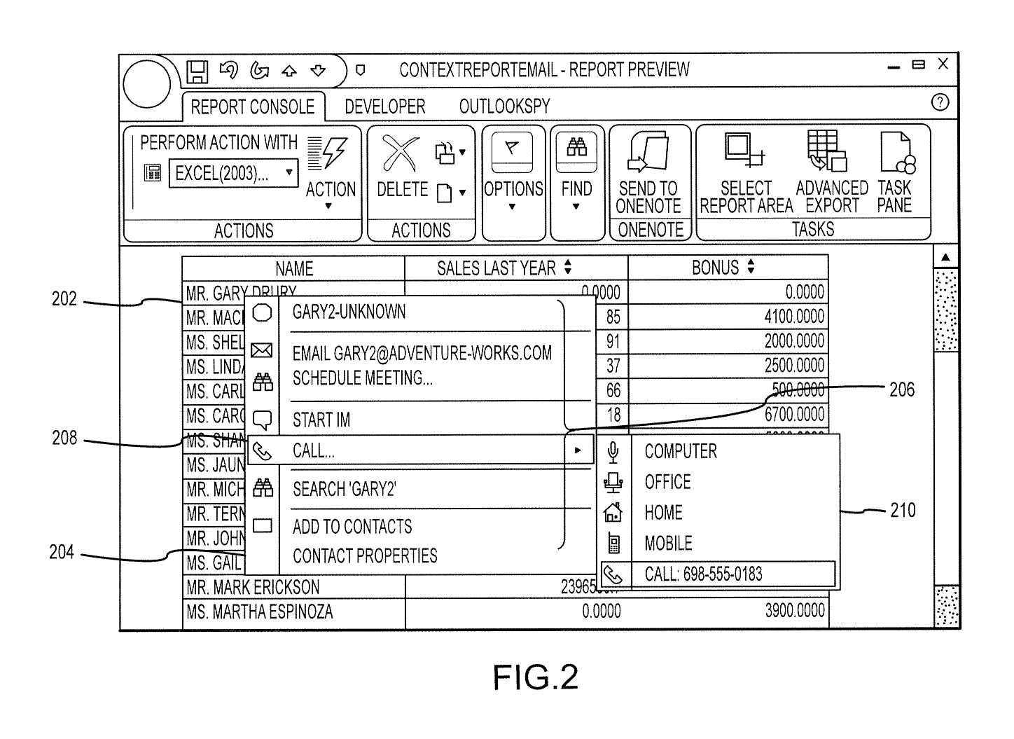

FIG. 2 shows a screen capture of contextual actions on a report field inside Microsoft® Outlook® with Microsoft® Office Communicator running. Referring now to FIG. 2, the user has clicked on report field 202, causing Context Menu 204 to pop up at the mouse click site. The Contextual Actions 206 at the report field location is expanded and now includes IM actions. The user has further clicked on Call Action 208, which causes Sub-Context Menu 210 to pop up at that mouse click location. Sub-Context Menu 210 includes: Computer, Office, Home, Mobile, and Call.

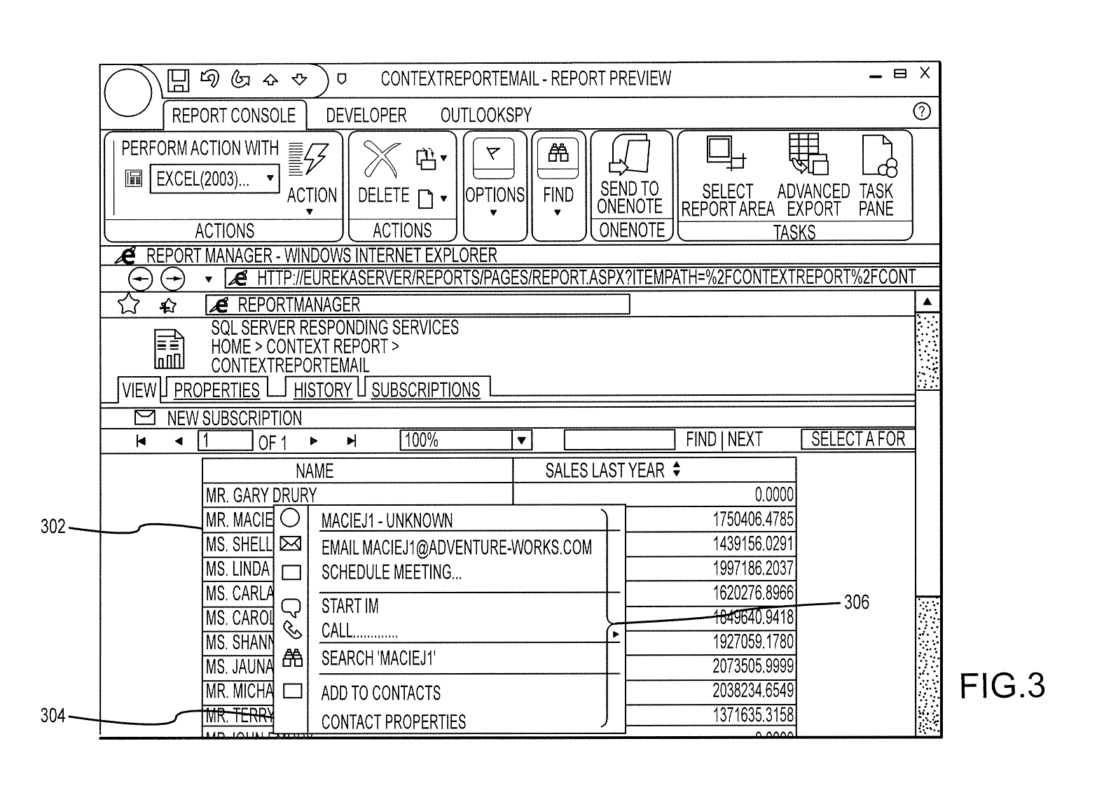

FIG. 3 shows a screen capture of contextual actions on a report field inside Microsoft® Internet Explorer. Referring now to FIG. 3, the simple business document shown above has been imported into Microsoft® Internet Explorer from a Report Manager or MOSS. The user has clicked on Report Field 302, causing Context Menu 304 to pop up at the mouse click site. The Contextual Actions 306 at the report field location includes IM actions and is identical to the Contextual Actions 206 of Context Menu 204 shown in FIG. 2.

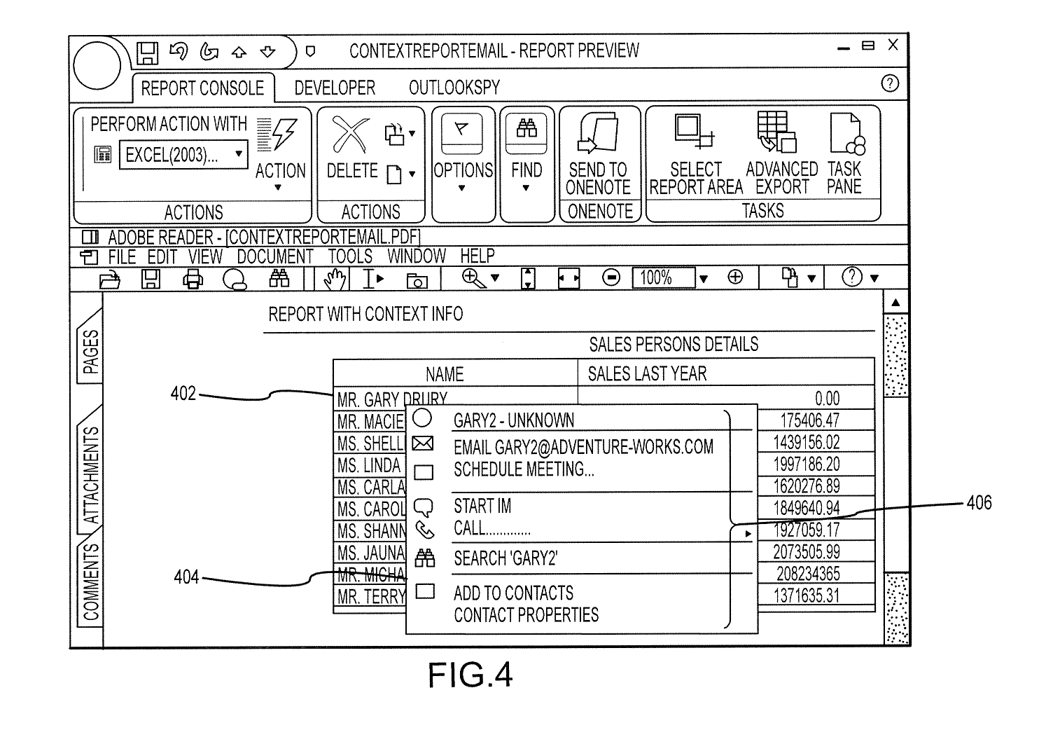

FIG. 4 shows a screen capture of contextual actions on a report field inside Adobe® Reader® in PDF format. Referring now to FIG. 4, the simple business document shown above has been imported into Adobe® Reader®. The user has clicked on Report Field 402, causing Context Menu 404 to pop up at the mouse click site. The Contextual Actions 406 at the report field location includes IM actions and is identical to the Contextual Actions 206 of Context Menu 204 shown in FIG. 2 and the Contextual Actions 306 of Context Menu 304 shown in FIG. 3.

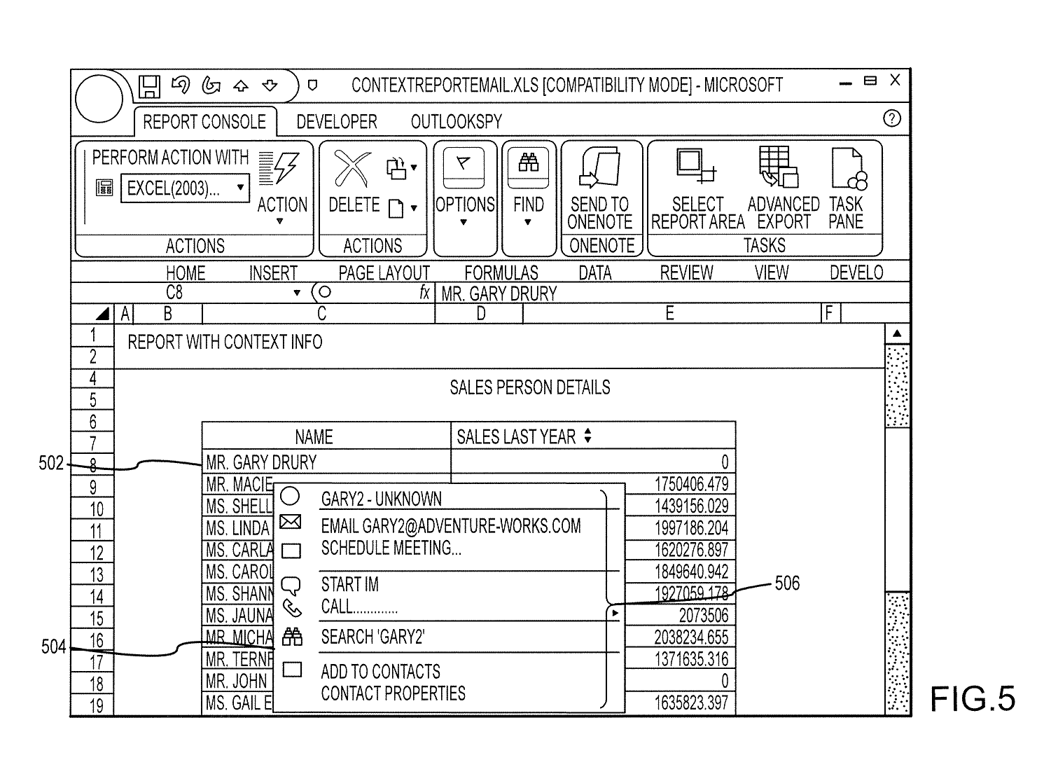

FIG. 5 shows a screen capture of contextual actions on a report field inside Microsoft® Excel®. Referring now to FIG. 5, the simple business document shown above has been imported into Microsoft® Excel®. The user has clicked on Report Field 502, causing Context Menu 504 to pop up at the mouse click site. The Contextual Actions 506 at the report field location includes IM actions and is identical to the Contextual Actions 206 of Context Menu 204 shown in FIG. 2, the Contextual Actions 306 of Context Menu 304 shown in FIG. 3, and the Contextual Actions 406 of Context Menu 404 shown in FIG. 4.

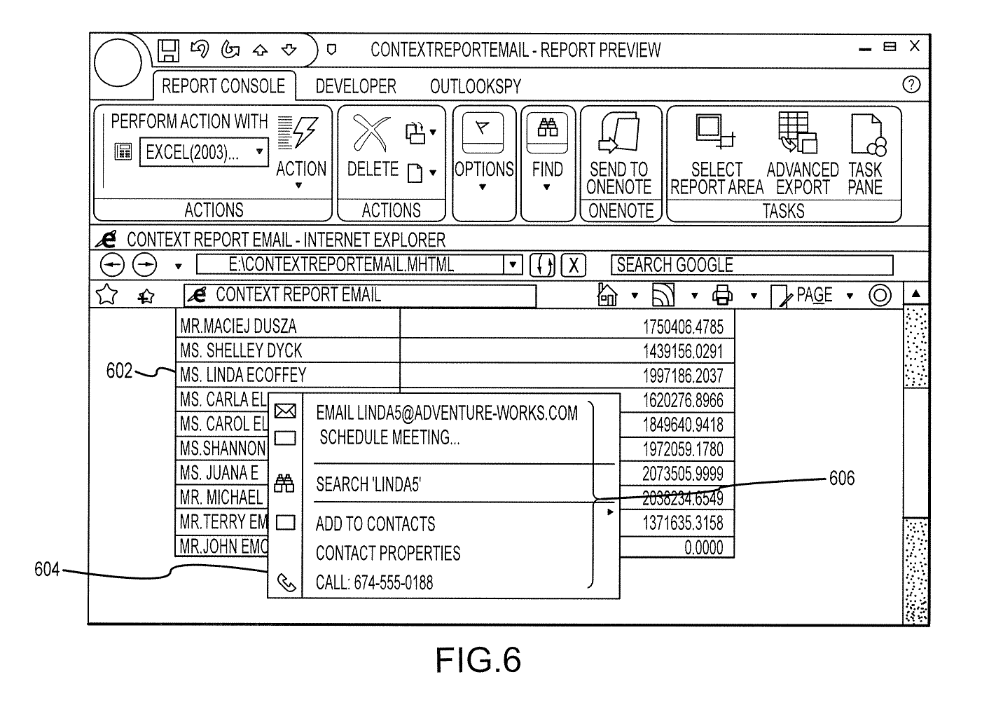

FIG. 6 shows a screen capture of contextual actions on a report field inside Microsoft® Internet Explorer in a web archive format. Referring now to FIG. 6, the simple business document shown above has been imported into Microsoft® Internet Explorer. The user has clicked on Report Field 602, causing Context Menu 604 to pop up at the mouse click site. Contextual Actions 606 includes: send an email, schedule a meeting, search, add to contacts, contact properties, and place a telephone call, and is identical to the Contextual Actions 106 of Context Menu 104 shown in FIG. 1.

Thus from FIGS. 1-6 it can be seen how the unique approach of provisioning contextual information behind data fields as a custom hyperlink URL, and then consuming it to provide contextual actions at that field, opens a new way of providing custom context based actions on the data contained in business documents. This approach allows seamless and consistent behavior, irrespective of the application and the environment, and offers tremendous value. This approach may be applied to other operating systems in more or less the same fashion depending upon the operating system's unique characteristics. More work may have to be done on some operating systems than others depending upon the features that are available as standard. Some additional programming may be required than that demonstrated above for the Windows® operating system.

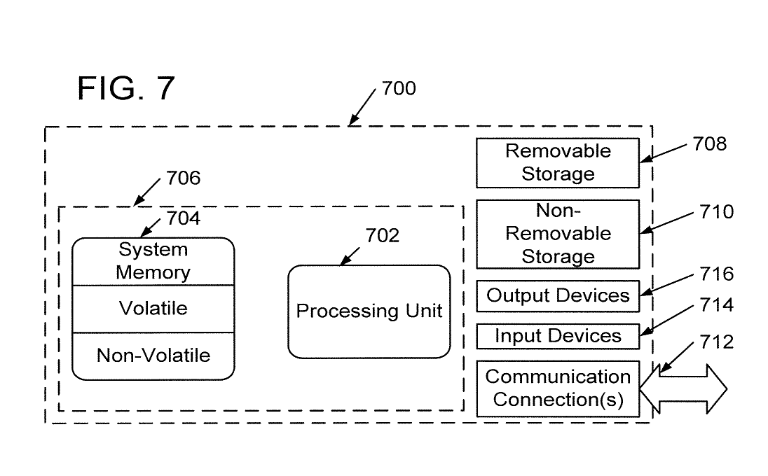

FIG. 7 shows a block diagram illustrating an exemplary operating environment. Referring now to FIG. 7, one example of a suitable Operating Environment 700 in which a software embodiment may be implemented is shown. This is only one example of a suitable operating environment and is not intended to suggest any limitation as to the scope of use or functionality. Other well known computing systems, environments, and/or configurations that may be suitable for use include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

In its most basic configuration, Operating Environment 700 typically includes at least one Processing Unit 702 and Memory 704. Depending on the exact configuration and type of computing device, Memory 704 may be volatile (such as RAM), non-volatile (such as ROM, flash memory, etc.) or some combination of the two. This most basic configuration is illustrated in FIG. 7 by Dashed Line 706. Further, Operating Environment 700 may also include Storage Devices (Removable, 708, and/or Non-Removable, 710) including, but not limited to, magnetic or optical disks or tape. Similarly, Operating Environment 700 may also have Input Device(s) 714 such as keyboard, mouse, pen, voice input, etc. and/or Output Device(s) 716 such as a display, speakers, printer, etc. Also included in the environment may be one or more Communication Connections, 712, such as LAN, WAN, point to point, etc. All of these devices are well known in the art and need not be discussed at length here.

Operating Environment 700 typically includes at least some form of computer readable media. Computer readable media can be any available media that can be accessed by Processing Unit 702 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Operating Environment 700 may be a single computer operating in a networked environment using logical connections to one or more remote computers. The remote computer may be a personal computer, a server, a router, a network PC, a peer device or other common network node, and typically includes many or all of the elements described above. The logical connections may include any method supported by available communications media. Such networking environments are commonplace in offices, enterprise-wide computer networks, intranets and the Internet.

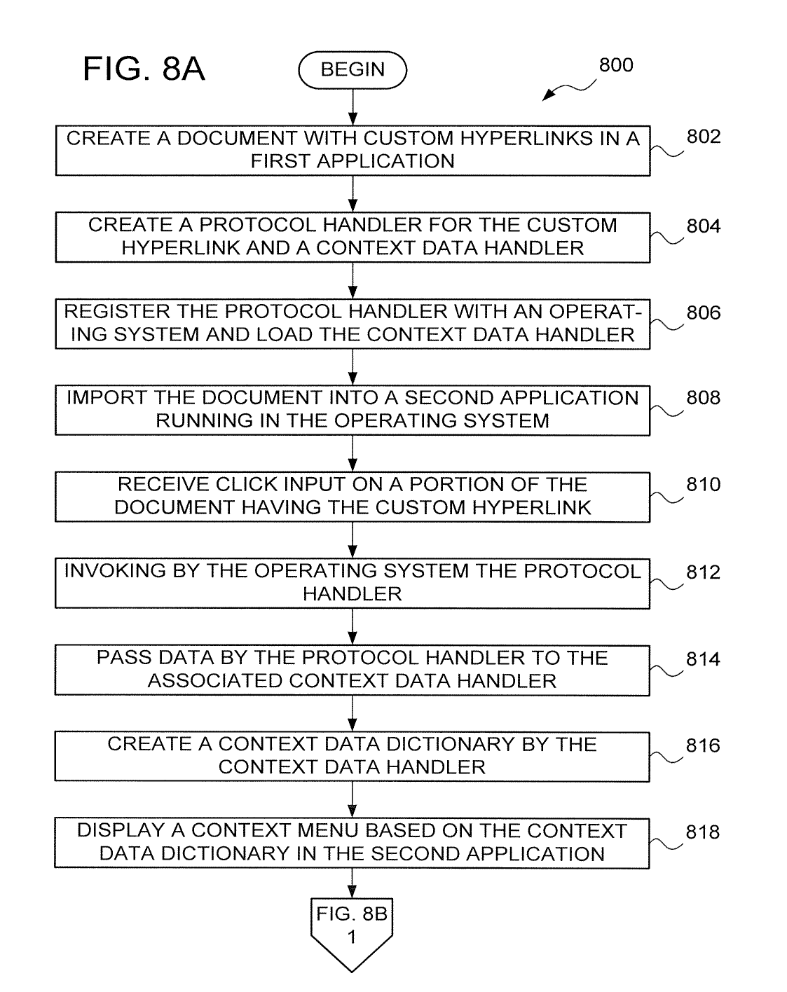

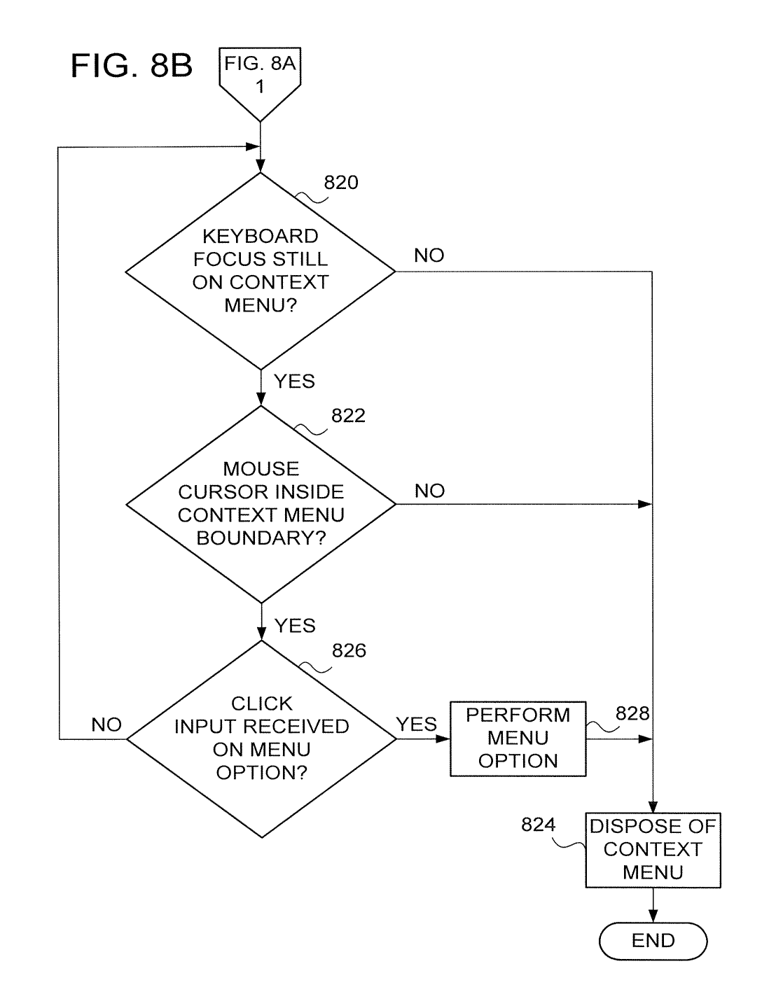

FIGS. 8A and 8B show the overall flow of an embodiment of provisioning context data and providing relevant actions based on the context data. Referring now to FIG. 8A, the method 800 begins in step 802 where a document is created in a first application that incorporates the custom hyperlinks described above into certain fields or locations within the document. Additional data, or metadata, is embedded in the hyperlinks that are associated with the field or location that is not displayed in the document at that field or location. In step 804 a Protocol Handler is created that is designed to recognize and handle these custom hyperlinks. In conjunction with the Protocol Handler, a Context Data Handler is also created. The Context Data Handler will consume the additional data embedded in the custom hyperlink. The Protocol Handler is registered with an operating system in step 806. The Context Data Handler is also loaded in the form of an operating system service, or as an add-in module of a running application.

In step 808 the document created in the first application is imported into a second application that is running in the operating system with the Protocol Handler and Context Data Handler. Click input is received in step 810 on one of the custom hyperlinks in the document. Upon receiving the click input, the operating system in step 812 invokes the Protocol Handler with the URL text of the hyperlink as the command line parameter. In step 814 the Protocol Handler passes the embedded metadata in the hyperlink to the Context Data Handler. The Context Data Handler in step 816 parses the metadata to create a Context Data Dictionary. The Context Data Handler then decides on the possible contextual actions that can be provided based upon the names in the Context Data Dictionary and upon the availability of the configured services in the second application. The Context Data Handler then displays in step 818 a Context Menu within the second application at the point of the click input. The Context Menu displayed is driven by the metadata, which does not have to appear in the Context Menu as displayed. A user may then click on any of the options provided in the displayed Context Menu.

Referring now to FIG. 8B, query step 820 determines if the keyboard focus is still on the Context Menu. If no, then in step 824 the Context Menu is disposed of and the method ends until a next hyperlink is clicked upon in step 810, at which time steps 812-828 may be repeated.

If the answer in query step 820 is yes, then query step 822 determines if the mouse cursor is still inside of the Context Menu boundary. If no, then in step 824 the Context Menu is disposed of and the method ends until a next hyperlink is clicked upon in step 810, at which time steps 812-828 may be repeated.

If the answer in query step 822 is yes, then query step 826 determines if click input has been received upon any of the Context Menu options. If no, flow returns to query step 820. If yes, then in step 828 the menu option clicked on is performed, and the context menu is disposed of in step 824. The method ends until a next hyperlink is clicked upon in step 810, at which time steps 812-828 may be repeated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications of the invention will suggest themselves without departing from the scope of the present invention.

What is claimed is:

1. A method for handling data within electronic documents, the method comprising the steps of:
(a) within an electronic document in a first application, provisioning through a custom hyperlink a metadata behind an actual data that is contained in a location in said electronic document, wherein said metadata is preserved when a format of said electronic document is transformed to a different format, or when said electronic document is transitioned into a second application;
(b) registering a protocol handler for said custom hyperlink with an operating system; and
(c) handling said metadata within said different format, or in said second application by said operating system, by invoking said protocol handler when said custom hyperlink is clicked on at said location in said electronic document, wherein based upon said metadata a menu of contextual actions is displayed at said location in said electronic document.

2. The method according to claim 1 further comprising the step of:
creating said custom hyperlink with a URL that has a protocol name segment, a handler name segment, and a context data segment having at least one URI encoded name-value pair.

3. The method according to claim 2 further comprising the step of:
loading a context data handler associated with said protocol handler as an operating system service, or as an add-in module.

4. The method according to claim 3 further comprising the steps of:
passing said context data segment by said protocol handler to said context data handler; and
creating by said context data handler a context data dictionary from said context data segment.

5. The method according to claim 4 further comprising the step of:
creating said menu of contextual actions based upon said context data dictionary and upon a configured services running in said operating system.

6. The method according to claim 3 further comprising the step of:
utilizing named shared memory as an inter-process communication mechanism between said protocol handler and said context data handler.

7. The method according to claim 1 further comprising the step of:
listening for a left mouse click on said custom hyperlink to invoke said protocol handler.

8. The method according to claim 1 wherein said operating system is a Windows® operating system.

9. A computer system for handling data within electronic documents, the computer system comprising:
an operating system running in the computer system;
a protocol handler registered with said operating system; and
a context data handler associated with said protocol handler and running as an operating system service, or running as an add-in module to an application running in said computer system;
wherein said protocol handler is invoked by said operating system when click input is received on a hyperlink having a custom protocol in a electronic document opened in said application, wherein a hyperlink URL is passed as a command line parameter to said protocol handler, and further wherein said protocol handler calls said context data handler to consume a metadata contained within said hyperlink, creating a context menu that is displayed on a display device of the computer system.

10. The system according to claim 9 wherein said hyperlink URL further comprises:
a protocol name segment;
a handler name segment; and
a context data segment having at least one URI encoded name-value pair.

11. The system according to claim 10 further comprising:
a context data dictionary constructed by said context data handler from said context data segment.

12. The system according to claim 9 further comprising:
a configured services running in said application, wherein said context menu includes menu options derived from said configured services and from a configured services in said computer system.

13. The system according to claim 9 further comprising:
an inter-process communication mechanism based upon named shared memory operating between said protocol handler and said context data handler.

14. The system according to claim 9 wherein said operating system is a Windows® operating system.

15. A method for handling data within electronic documents, the method comprising the steps of:
(a) creating a electronic document in a first application, said electronic document having at least one custom hyperlink;
(b) creating a protocol handler to handle said at least one custom hyperlink;
(c) registering said protocol handler with an operating system of a computer system;
(d) creating a context data handler that is called by said protocol handler;
(e) loading said context data handler as an operating system service or as an add-in module to an application running in said computer system;
(f) importing said electronic document into a second application running in said computer system;
(g) receiving click input on said at least one custom hyperlink;
(h) invoking by said operating system said protocol handler;
(i) passing metadata from said at least one hyperlink to said context data handler;
(j) creating by said context data handler a context data dictionary from said metadata; and
(k) displaying a context menu based upon said context data dictionary in said second application.

16. The method according to claim 15 further comprising the step of:
disposing of said context menu when a keyboard focus is no longer on said context menu.

17. The method according to claim 15 further comprising the step of:
disposing of said context menu when a menu cursor is no longer inside a boundary of said context menu.

18. The method according to claim 15 further comprising the step of:
listening for click input on a one of a plurality of menu options in said context menu.

19. The method according to claim 18 further comprising the step of:
when said click input is received, performing said one of said plurality of menu options; and
disposing of said context menu.

20. The method according to claim 15 wherein said operating system is a Windows® operating system.
